(19) United States
(12) Patent Application Publication
(10) Pub. No.: US 2010/0169390 A1
(43) Pub. Date: Jul. 1, 2010

(54) FILE TRANSFER METHOD AND TERMINAL ADAPTED THERETO

(75) Inventors: Kang Seo Park, Gyeonggi-do (KR); Young Il Choi, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/648,585

(22) Filed: Dec. 29, 2009

(30) Foreign Application Priority Data
Dec. 30, 2008 (KR) 10-2008-0137035

(51) Int. Cl. G06F 17/30

(52) U.S. Cl. 707/822; 707/E17.01

(57) ABSTRACT

A file transfer method and a terminal adapted thereto are disclosed. When a moving image file request signal is revived, a determination is made as to whether the moving image file to be transferred is in an ISO base media file format. If the moving image file to be transferred is in an ISO base media file format, a movie (moov) box is rearranged so that it is in front of a media data (mdat) box in the moving image file, in terms of the transfer sequence. The moov box is one of the boxes contained in the moving image file and contains detailed information to reproduce moving image data. After that, the moving image file composed of the rearranged boxes is transferred.

### CLAIM OF PRIORITY

This application claims the benefit of the earlier filing date, pursuant to 35 USC 119, to that patent application entitled “FILE TRANSFER METHOD AND TERMINAL ADAPTED THERETO” filed in the Korean Intellectual Property Office on Dec. 30, 2008 and assigned Serial No. 10-2008-0137035, the contents of which are incorporated herein by reference.

### BACKGROUND OF THE INVENTION

1. Field of the Invention

The present invention relates to file management and more particularly to a file transfer system.

2. Description of the Related Art

An international organization for standardization (ISO) base media file format is designed to process media files, for example, through compressing and storing moving image files. The ISO base media file format is used to encode moving image files by a unit that is conventionally terms “a box” or “an atom”. The ISO base media file format can be applied to techniques for compressing a variety of moving images, such as MPEG4, H.264, etc. The ISO base media file format has established the standard for a media file format that becomes a base of the format of a plurality of moving images, such as 3gpp, 3g2, skm, mp4, k3g, etc.

In general, a terminal transfers a moving image file stored as an ISO base media file (called hereinafter a moving image file of an ISO base media file format) to a receiving terminal, sequentially, starting from the first portion of the moving image, in a manner similar to transferring types other files. In that case, the terminal cannot identify the moving image file that it is currently receiving until it has received the entire moving image file. If the terminal performs a termination operation before it receives the entire moving image file, it cannot reproduce the moving image file up to the termination point as the entire file has not been transferred.

Therefore, a system is needed to reproduce partially received moving image file.

### SUMMARY OF THE INVENTION

The present invention provides a method that rearranges and transfers moving image files based on an ISO base media file format (ISO/IEC 14496-12, MPEG-4 part 12) so that the moving image files can be reproduced in a terminal while they are being received.

The present invention further provides a terminal adapted to the method for rearranging and transferring moving image files based on an ISO base media format.

In accordance with an exemplary embodiment of the present invention, the present invention provides a file transfer method including: receiving a moving image file request signal; determining whether the moving image file to be transferred is in an ISO base media file format; rearranging a movie (moov) box so that it is in front of a media data (mdat) box in the moving image file, in terms of the transfer sequence, if the moving image file to be transferred is in an ISO base media file format, wherein the moov box is one of the boxes contained in the moving image file and contains detailed information to reproduce moving image data; and transferring the moving image file composed of the rearranged boxes.

In accordance with another exemplary embodiment of the present invention, the present invention provides a terminal including: an external terminal connecting unit, linked to an external terminal, for receiving a moving image file request signal and transferring a moving image file corresponding to the received request signal to the external terminal; a storage unit for storing the moving image file; and a controller for receiving the moving image file request signal, determining whether the moving image file corresponding to the request signal is in an ISO base media file format, rearranging a movie (moov) box so that it is in front of an media data (mdat) box in the moving image file, in terms of the transfer sequence, if the moving image file is in an ISO base media file format, and transferring the moving image file composed of the rearranged boxes to the external terminal. The moov box is one of the boxes contained in the moving image file and contains detailed information to reproduce moving image data.

### BRIEF DESCRIPTION OF THE DRAWINGS

The features and advantages of the present invention will become more apparent from the following detailed description in conjunction with the accompanying drawings, in which:

FIG. 1 is a schematic block diagram illustrating an exemplary terminal according to an embodiment of the present invention;

FIG. 2A and FIG. 2B are views illustrating boxes included in a moving image file, according to an embodiment of the present invention;

FIG. 3 is a flow chart that describes a method for transferring/receiving moving image files between terminals, according to an embodiment of the present invention;

FIG. 4 is a flow chart that describes a method for transferring moving image files, according to an embodiment of the present invention; and

FIG. 5 is a flow chart that describes a method for rearranging moving image files, according to an embodiment of the present invention.

### DETAILED DESCRIPTION OF THE INVENTION

Exemplary embodiments of the present invention are described herein in detail with reference to the accompanying drawings. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

The term ‘terminals’ refer to information processing devices that can generate, store, and output moving image files, for example portable terminals, computers, television sets, personal digital assistants (PDA), smartphones, etc. The terminals can be linked to other terminals in a wired or wireless manner so as to transfer and receive moving image files among one or more terminals.

The term ‘moving image files’ include moving image data and detailed information regarding the moving image data, which can be stored in the terminals. If the moving image file is formed in an ISO base media file format, it is composed of a unit of a plurality of boxes (or atoms) that store moving image data and detailed information corresponding to the moving image data. The boxes are classified into a file information (ftyp) box that indicates a file format, a media data (mdat) box for containing moving image data, a movie (moov) box for containing detailed information related to the reproduction of moving image data, etc. The moving image data represents each image frame or sound data included in a moving image file.

Exemplary embodiments of the present invention are described in detail with reference to the accompanying drawings. In the following description, the same reference numbers are used throughout the drawings to refer to the same or similar parts. Detailed descriptions of well-known functions and structures incorporated herein may be omitted to avoid obscuring the subject matter of the present invention.

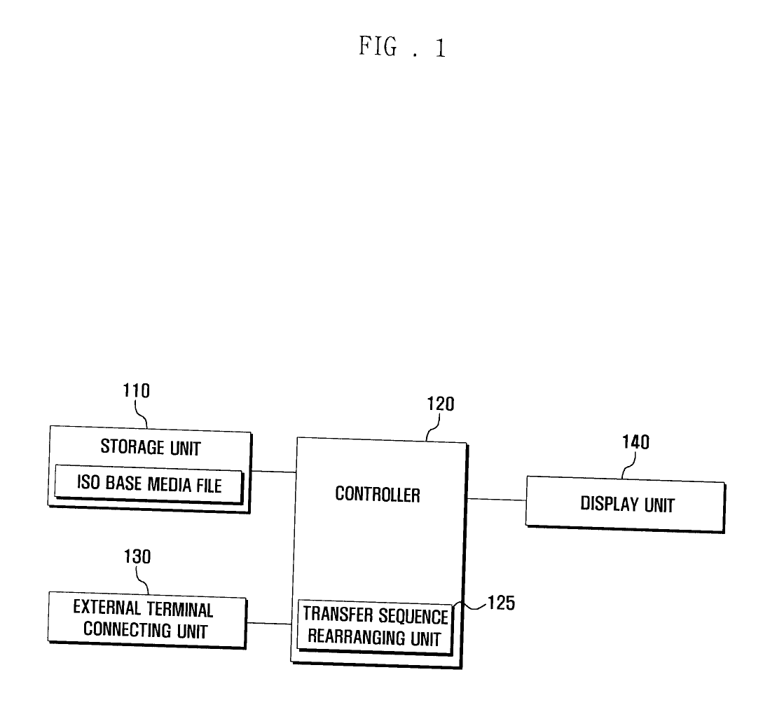

FIG. 1 is a schematic block diagram illustrating the terminal according to an embodiment of the present invention.

Referring to FIG. 1, the terminal 100 includes a storage unit 110, a controller 120, an external terminal connecting unit 130, and a display unit 140.

The storage unit 110 stores application programs for executing a variety of functions in the terminal 100 and various types of data generated when the terminal 100 is operated. In an embodiment of the present invention, the storage unit 110 can store moving image files of an ISO base media file format. The moving image file of an ISO base media file format is composed of a unit of a plurality of boxes. Each box stores moving image data and meta-data for storing detailed information for reproducing a moving image file. The following table 1 describes boxes.

TABLE 1

| | Box | Container included in box | | | | | Detailed information contents |
|---|---|---|---|---|---|---|---|
| (1) | ftyp | | | | | | file type and compatibility |
| (2) | moov | | | | | | container for all the meta-data |
| | | mvhd | | | | | movie header, |
| | | | | | | | overall declarations |
| | | trak | | | | | container for an individual track |
| | | | | | | | or stream |
| | | | tkhd | | | | track header, overall information |
| | | | | | | | about the track |
| | | | tref | | | | track reference container |
| | | | edts | | | | edit list container |
| | | | | elst | | | an edit list |
| | | | mdia | | | | container for the media |
| | | | | | | | information in a track |
| | | | | mdhd | | | media header, overall information |
| | | | | | | | about the media |
| | | | | hdlr | | | handler, declares the media |
| | | | | | | | (handler) type |
| | | | | minf | | | media information container |
| | | | | | vmhd | | video media header, overall |
| | | | | | | | information (video track only) |
| | | | | | smhd | | sound media header, overall |
| | | | | | | | information (sound track only) |
| | | | | | hmhd | | hint media header, overall |
| | | | | | | | information (hint track only) |
| | | | | | mpeg | | mpeg stream headers |
| | | | | | dinf | | |
| | | | | | | dref | data reference box, declares |
| | | | | | | | source(s) of media data in track |
| | | | | | stbl | | sample table box, container for |
| | | | | | | | the time/space map |
| | | | | | | stts | (decoding) time-to-sample |
| | | | | | | ctts | |
| | | | | | | stsc | sample-to-data, partial |
| | | | | | | | data-offset |
| | | | | | | | information |
| | | | | | | stsz | sample sizes (framing) |
| | | | | | | stss | |
| | | | | | | stco | data offset, partial data-offset |
| | | | | | | | information |
| | | | | | | stsh | shadow sync sample table |
| | | | | | | stdp | sample degradation priority |
| (3) | mdat | | | | | | media data container |
| (4) | free | | | | | | |
| (5) | skip | | | | | | free space |
| (6) | udta | | | | | | user-data, copyright etc |

As described in Table 1, the ‘ftyp’ box stores information regarding a file type and compatibility. The format of a moving image file may include a file type based on the ISO base media file format, such as skm, 3gp, 3gpp2, mpeg4, etc.

The ‘moov’ box is composed of a plurality of containers that store detailed information for reproducing moving image files. The containers, included in the moov box, are classified into a track container for storing stream information corresponding to individual moving image data, an edts container for storing an elst that represents information regarding the entire time period of moving image data and information regarding the starting time and the duration of the moving image data, and an mdia container for storing information related to moving image data. The containers may further include other sub-containers.

In particular, the mdia container stores a stbl container that contains information regarding the decoding time period and decoding sequence of moving image data. The stbl container contains a stts container serving as a time period for decoding a sample, a ccts container serving as a time period for displaying a sample in the remaining time from the decoding time period, a stss container serving as the number of key frame samples, a stsh container serving as a shadow sync sample indicating the stts, a stsc container indicating which moving image data a corresponding sample contains, a stsz container representing the size of each sample, a stco container that represents offset values by samples of individual moving image data in a moving image file.

The ‘mdat’ box contains moving image and sound data. The ‘free’ box and the ‘skip’ box are empty and may additionally store detailed information. The ‘udta’ box stores retained information by a user, for example, the name of a user who generates a moving image file.

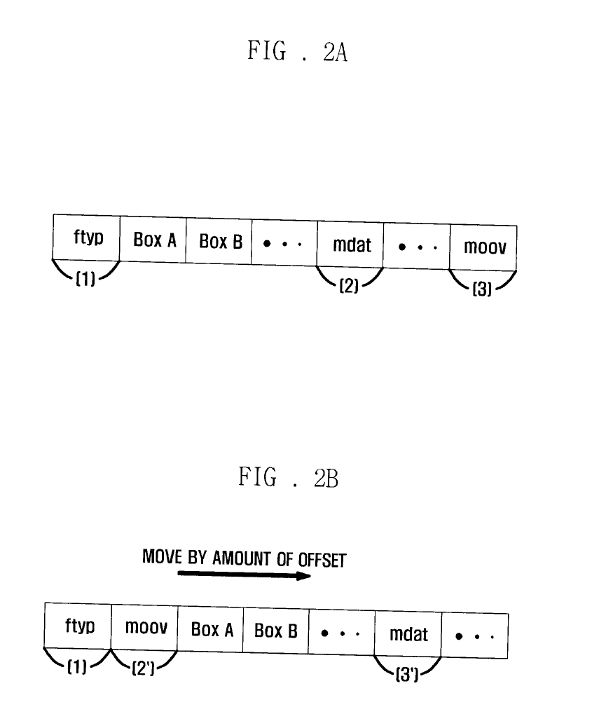

The controller 120 controls the entire operation and state of the terminal. In an embodiment of the present invention, the controller 120 receives a moving image file request signal from an external terminal via the external terminal connecting unit 130 and transfers a moving image file of an ISO base media file format, stored in the storage unit 110, to the external terminal (not shown). To this end, the controller 120 includes a transfer sequence rearranging unit 125 for rearranging a moving image file of an ISO base media file format stored in the storage unit 110. The transfer sequence rearranging unit 125 rearranges the moov box of a moving image file so that it is in front of the mdat box in terms of transfer sequence. A detailed description will be provided later regarding the method for rearranging a moving image file in the transfer sequence rearranging unit 125, with reference to FIGS. 2A and 2B.

The external terminal connecting unit 130 is linked to an external terminal (not shown) in a wired or wireless manner and allows for the exchange of information between the external terminal and the controller 120. When the external terminal connecting unit 130 is linked to an external terminal in a wired manner, it may be implemented with a cable connecting unit or a USB connection unit. Alternatively, when the external terminal connecting unit 130 is linked to an external terminal in a wireless manner, it may be implemented with a communication unit, a Bluetooth communication unit, an IR communication unit, a WIFI unit and an Internet unit. The external terminal connecting unit 130 receives a moving image file request signal, in a wired or wireless manner, from the external terminal, and outputs it to the controller 120. The external terminal connecting unit 130 transfers a moving image file corresponding to the moving image file request signal to the external terminal under the control of the controller 120.

The display unit 140 may display a variety of information related to the entire operation and state of the terminal 100. It can output a moving image file, being transferred to or received from the external terminal, under the control of the controller 120.

In the foregoing description, the configuration of the terminal 100 for rearranging moving image files to be transferred was explained. In the following description, a description is provided regarding the method for rearranging a moving image file in the transfer sequence rearranging unit 125, with reference to FIGS. 2A and 2B.

FIG. 2A and FIG. 2B are views illustrating boxes included in a moving image file, according to an embodiment of the present invention.

As shown in FIG. 2A, the moving image file of an ISO base media file format, stored in the storage unit 110, is composed of a plurality of boxes. Each box contains information related to moving image files.

For example, the ftyp box (1) indicates types of moving image files, such as 3gp, k3g, skm, 3g2, and mpeg4, and is always located at the first position of the moving image file. The mdat box (2) contains most of the moving image file, i.e., moving image data, and may be located at a known position in the moving image file. The moov box (3) contains detailed information necessary for reproducing moving image data stored in the mdat box (2). The moov box (3) may be located at a known position in the moving image file, but, in general, is attached to the moving image file after the mdat bax (2) has been generated. Therefore, the moov box (3) is, in general, located at the end of the moving image file.

Meanwhile, Box A and Box B represent arbitrary boxes other than the ftyp, mdat and moov boxes. The contents of Box A and Box B are not relevant to the invention described herein and, hence, are not discussed to avoid obscuring the description of invention.

The transfer sequence rearranging unit 125 rearranges the transfer sequence so that the moov box is located in front of the mdat box, as shown in FIG. 2B, and then transfers a corresponding moving image file.

That is, as shown in FIG. 2B, the transfer sequence rearranging unit 125 rearranges the position of the moov box (2′), which is generally located in the last portion of the moving image file, so that it is in front of the mdat box (3′). Most values stored in the boxes included in the moving image file are independent from the locations of the boxes. Therefore, the values of the boxes are not affected by a change in the sequence of the boxes. However, the change in the sequence of the boxes affects the values of the components of the stco container contained in the moov box. The values of the components of the stco container refer to offsets of each sample related to moving image data contained in the mdat box, with respect to the beginning portion of the moving image file. When the moov box is moved in front of the mdat box, each sample related to the moving image data contained in the mdat box is moved back by the size of the moov box. This movement represents an offset value that must no be considered and compensated for. Therefore, the offset value corresponding to the size of the moov box is added to the value of each component of the stco container contained in the moov box. Accordingly, the changed value of the component of the stco container is identical to the offset value of each sample contained in the mdat box, which is altered according to the movement of the moov box. Thus, when the moving image file, where boxes have been rearranged, is reproduced, although the moov box is moved, no error occurs.

When the transfer sequence rearranging unit 125 rearranges the transfer sequence of a moving image file, the controller 120 transfers the moving image file to an external terminal, through the external terminal connecting unit 130, according to the rearranged transfer sequence. For example, if the boxes are arranged in the moving image file as shown in FIG. 2B, the controller 120 transfers the ftyp box (1) first, the moov box (2′) second, and next Box A, Box B, . . . , and the mdat box (3′), through the external terminal connecting unit 130.

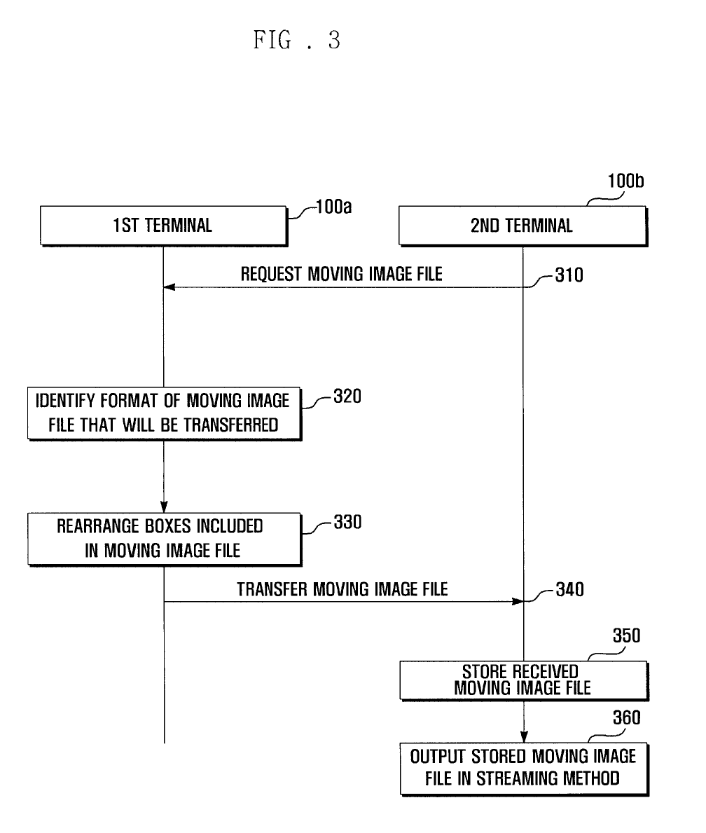

In the following description, a detailed description is provided regarding methods for transferring moving image files in the terminal 100, with reference to FIGS. 3 to 5.

FIG. 3 is a flow chart that describes a method for transferring/receiving moving image files between first and second terminals, according to an embodiment of the present invention.

Referring to FIG. 3, when the first terminal 100a receives a moving image file request signal from the second terminal 100b (310), it identifies the format of a moving image file to be transferred to the second terminal 100b (320). That is, the first terminal 100a determines whether the format of a moving image is an ISO base media file format.

If the first terminal 100a determines the format of a moving image to be transferred is an ISO base media file format, it rearranges boxes included in the moving image file (330). To this end, the first terminal 100a moves the moov box in front of the mdat box in the moving image file. That is, the first terminal 100a detects the position of the moov box containing detailed information necessary for reproducing a moving image file. If the first terminal 100a ascertains that the moov box is located after the mdat box, it moves the moov box next to the ftyp box. The first terminal 100a calculates an additional offset value of the mdat box according to the change in the transfer sequence and then adds the calculated additional offset value to each component of the stco container. After that, the first terminal 100a transfers the moving image file to the second terminal 100b according to the rearranged transfer sequence (340). The first terminal 100a may transfer the boxes, included in the moving image file, to the second terminal 100b according to the rearranged transfer sequence.

The second terminal 100b receives the moving image file from the first terminal 100a and then stores it in the storage unit 110 (350). After that, the second terminal 100b outputs the stored moving image file on the screen, in a steaming manner, (360). The streaming manner refers to a method that the terminal reproduces a moving image file that is being received in real time.

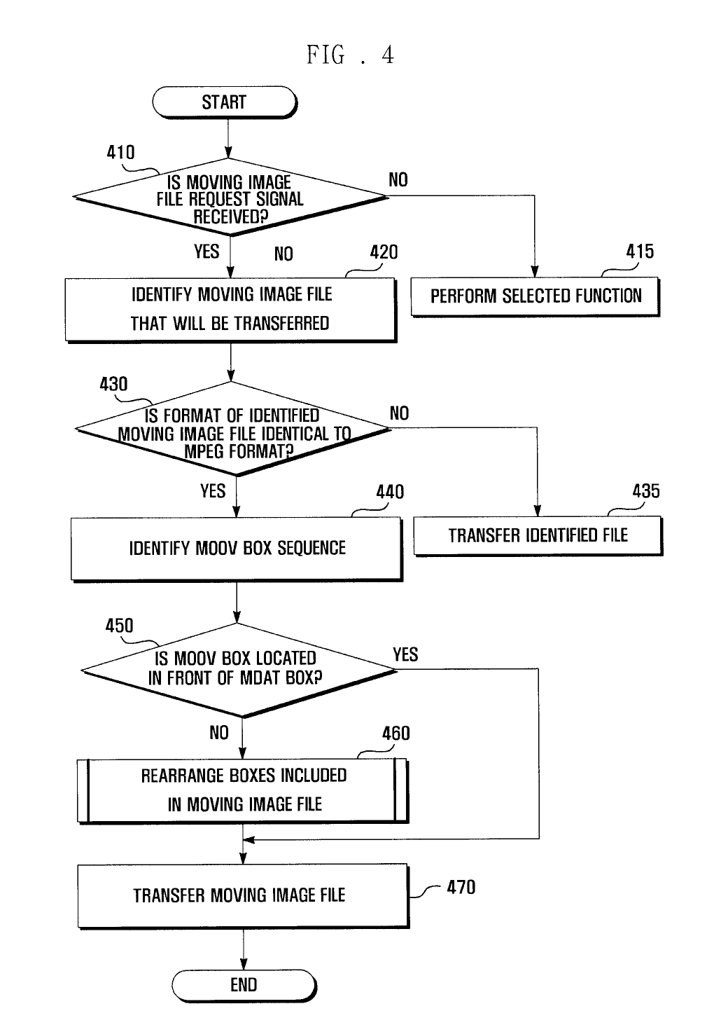

FIG. 4 is a flow chart that describes a method for transferring moving image files in the first terminal 100a, according to an embodiment of the present invention.

Referring to FIG. 4, the controller 120 determines whether a terminal receives a moving image file request signal from an external terminal via the external terminal connecting unit 130 (410).

If the controller 120 ascertains that a terminal receives a signal other than the moving image file request signal from an external terminal at 410, the controller 120 performs a selected function corresponding to the received signal (415). Examples of the selected function are a voice or video call function, a camera function, etc. if the terminal 100 is implemented with a portable terminal, such as a cellular telephone. Alternatively, if the terminal 100 is implemented with a computer, the selected function may include a text writing function, a messenger function, etc.

However, if the controller 120 determines that a moving image file request signal has been received (410), the controller 120 identifies the format of a moving image file to be transferred (420). After that, the controller 120 determines whether the identified format of the moving image file is an ISO base media file format (430).

If the controller 120 ascertains that the identified format of the moving image file is not an ISO base media file format at 430, it transfers the identified moving image file to the external terminal via the external terminal connecting unit 130 (435), in a conventional manner.

However, if the controller 120 ascertains that the identified format of the moving image file is an ISO base media file format (430), it identifies the position of the moov box in the moving image file (440). After that, the controller 120 determines whether the identified moov box is located in front of the mdat box (450).

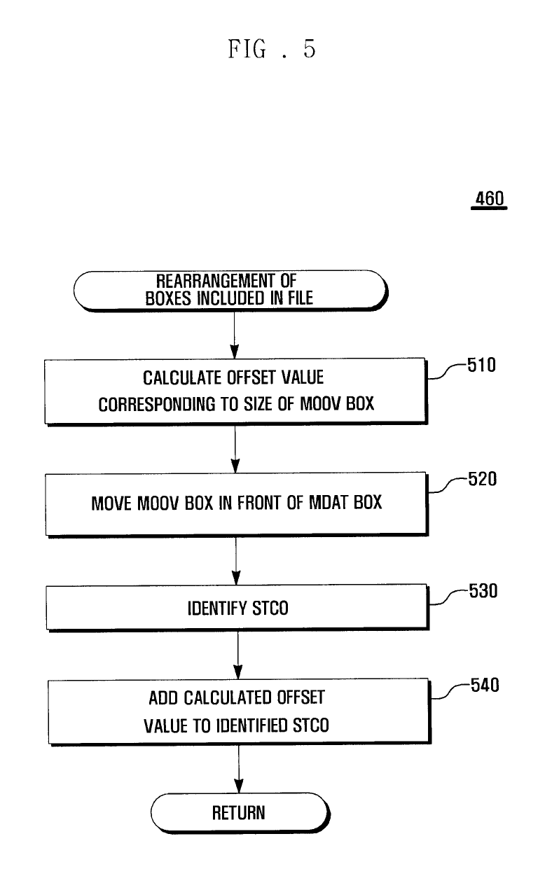

If the controller 120 ascertains that the identified moov box is not located in front of the mdat box at 450, it rearranges the boxes in the moving image file (460). The arrangement of the boxes is explained with reference to FIG. 5.

After rearranging the moving image file at 460, the controller 120 transfers the moving image file to the external terminal via the external terminal connecting unit 130 (470). The controller 120 sequentially transfers the boxes contained in the moving image file to the external terminal.

However, if the controller 120 ascertains that the identified moov box is located in front of the mdat box at 450, it proceed with step 470 and transfers the identified moving image file to the external terminal via the external terminal connecting unit 130.

Alternatively, the controller 120 may receive a moving image file containing rearranged boxes from an external terminal and then store it in the storage unit 110. In that case, the controller 120 transfers the moving image file to the external terminal, without performing rearrangement as the file is already in the desired format.

FIG. 5 is a flow chart that describes a process for rearranging a moving image file in first terminal 100a, at step 460 of FIG. 4, according to an embodiment of the present invention.

Referring to FIG. 5, the controller 120 identifies the size of the moov box and calculates an offset value corresponding to the identified size of the moov box (510). The controller 120 moves the moov box in front of the mdat box (520). It is preferable that the moov box is located immediately after the ftyp box. If the moov box is located after the ftyp box, the controller 120 moves the boxes, which were located next to the ftyp box, back according to the size of the moov box.

As would be appreciated the term “re-arrange” or “move” is not to be considered literally but is used in the figurative context. Thus, in one aspect of the invention, a box may be “moved” or the sequence “re-arranged” by changing an order of a series of pointers that represent a sequence in which boxes are to be transferred. The pointers may be contained within a list of pointers that are sequentially accessed to determine the box next to be transferred. Or the pointers may represent values contained within each box that points to the next box to be transferred. Hence, while the physical location of a box may remain the same, its order within the transfer sequence may be altered by shifting the order of associated pointers.

After that, the controller 120 identifies the stco container contained in the moov box (530). The stco container refers to information regarding an offset value of samples by moving image data contained in the mdat box, with respect to the beginning portion of the moving image file. Next, the controller 120 adds the calculated offset value to the identified stco container in the moov box (540).

As described above, although the embodiment has been explained as the terminal 100 rearranges a moving image file of an ISO base media file format and then transfers it to the other terminal, it can be modified in such a way that the terminal 100 can transfer a moving image based on an ISO base media file format to the other external terminal via a site linked to the Internet. That is, if a terminal 100 receives a moving image file request signal from the other terminal, an Internet site provider determines whether the moving image file corresponds to a moving image file of an ISO base media file format. If the Internet site provider ascertains that the moving image file corresponds to a moving image file of an ISO base media file format, the internet site provider detects the position of the moov box as one of the boxes contained in the moving image file. If the Internet site provider ascertains that the moov box is located behind the mdat box, it calculates an offset value corresponding to the size of the moov box. After that, the Internet site provider moves the moov box in front of the mdat box. Next, the Internet site provider identifies the stco container contained in the moov box and then adds the calculated offset value to the identified stco container. After that, the Internet site provider transfers the boxes, included in the moving image file, to the terminal that has requested the moving image file, according to the rearranged transfer sequence.

As described above, the file transfer method and the terminal adapted thereto, according to the present invention, do not re-encode a moving image file when a moving image file of an ISO base media file format is being transferred but re-arranges only the transfer sequence of internal boxes of the moving image file and then transfers it to the receiving terminal. Therefore, the receiving terminal can receive a moving image file and simultaneously reproduce the received moving image file, although it does employ an additional streaming protocol. In addition, although the transfer of a moving image file is interrupted, the receiving terminal can reproduce the moving image that it has received until the transfer is interrupted.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A file transfer method comprising:
receiving a moving image file request signal;
determining whether the moving image file to be transferred is in an ISO base media file format;
rearranging a movie (moov) box so that it is in front of a media data (mdat) box in the moving image file, in terms of the transfer sequence wherein the moov box is one of the boxes contained in the moving image file and contains detailed information to reproduce moving image data; and
transferring the moving image file composed of the rearranged boxes.

2. The file transfer method of claim 1, wherein rearranging a moov box so that it is in front of an mdat box comprises:
identifying a position of the moov box;
determining whether the position of the moov box is located in front of the position of the mdat box; and
moving the moov box in front of the mdat box if the position of the moov box is not located in front of the position of the mdat box.

3. The file transfer method of claim 2, wherein moving the moov box in front of the mdat box comprises:
calculating an offset value corresponding to the size of the moov box;
identifying an stco container corresponding to the offset value of samples by moving image data, wherein the stco container is contained in the mdat box; and
adding the calculated offset value to the stco container.

4. The file transfer method of claim 2, wherein the moving image file comprises:
a ftyp box indicating a file type, an mdat box containing moving image data, and a moov box containing detailed information to reproduce moving image data.

5. A terminal comprising:
an external terminal connecting unit, for receiving a moving image file request signal and transferring a moving image file corresponding to the received request signal;
a storage unit for storing the moving image file; and
a controller for receiving the moving image file request signal, determining whether the moving image file corresponding to the request signal is in an ISO base media file format, rearranging a movie (moov) box so that it is in front of a media data (mdat) box in the moving image file, in terms of the transfer sequence, if the moving image file is in an ISO base media file format, and transferring the moving image file composed of the rearranged boxes to the external terminal,
wherein the moov box is one of the boxes contained in the moving image file and contains detailed information to reproduce moving image data.

6. The terminal of claim 5, wherein the controller determines whether the position of the moov box is located in front of the position of the mdat box, and moves the moov box in front of the mdat box if the position of the moov box is not located in front of the position of the mdat box.

7. The terminal of claim 6, wherein the controller calculates an offset value corresponding to the size of the moov box, identifies a stco container corresponding to the offset value of samples by moving image data, wherein the stco container is contained in the mdat box, and adds the calculated offset value to the stco container.

8. An apparatus for performing a file transfer comprising:
a processor in communication with a memory, the memory including code which when accessed by the processor causes the processor to:
receive a moving image file request signal;
determine whether the moving image file to be transferred is in an ISO base media file format comprising: a ftyp box indicating a file type, an mdat box containing moving image data, and a moov box containing detailed information to reproduce moving image data;
rearrange the movie (moov) box so that it is in front of the media data (mdat) box in the moving image file, in terms of the transfer sequence wherein the moov box is one of the boxes contained in the moving image file and contains detailed information to reproduce moving image data; and
transfer the moving image file composed of the rearranged boxes.

9. The apparatus of claim 8, wherein rearranging the moov box so that it is in front of the mdat box comprises:
identifying a position of the moov box;
determining whether the position of the moov box is located in front of the position of the mdat box; and
moving the moov box in front of the mdat box if the position of the moov box is not located in front of the position of the mdat box.

10. The apparatus of claim 9, wherein moving the moov box in front of the mdat box comprises:
calculating an offset value corresponding to the size of the moov box;
identifying an stco container corresponding to the offset value of samples by moving image data, wherein the stco container is contained in the mdat box; and
adding the calculated offset value to the stco container.

11. The apparatus of claim 8, wherein moving image file includes a plurality of pointers associated with each box, the pointers representing an order of transferring the boxes.

12. The apparatus of claim 11, wherein the pointers are sequentially ordered in the order of transfer.

13. The apparatus of claim 11, wherein the pointers are contained within corresponding boxes and refer to a next box to be transferred.

14. The apparatus of claim 11, wherein rearranging the boxes comprises reordering the pointers in a desired order of transfer.

15. The apparatus of claim 11, wherein rearranging the boxes comprises physically altering the position of the moov box.
